(19) United States
(12) Patent Application Publication
(10) Pub. No.: US 2026/0136181 A1
(43) Pub. Date: May 14, 2026

(54) APPARATUS AND METHOD FOR DEVICE IDENTIFICATION IN WIRELESS LOCAL AREA NETWORK

(71) Applicant: Nokia Technologies Oy, Espoo (FI)

(72) Inventors: Orhan Okan MUTGAN, Munich (DE); Zhijie YANG, Shanghai (CN); Yi Ming JIANG, Shanghai (CN); Gang CHENG, Shanghai (CN)

(21) Appl. No.: 19/119,328

(22) PCT Filed: Oct. 10, 2022
(86) PCT No.: PCT/CN2022/124466

§ 371 Date: Apr. 8, 2025

(51) Int. Cl. H04W 12/06; H04W 84/12

(52) U.S. Cl. CPC H04W 12/06; H04W 84/12

(57) ABSTRACT

Embodiments of the present disclosure provide an apparatus and a method for device identification in wireless local area network. A first apparatus (50) comprising means (510) configured for: performing a first authentication procedure between the first apparatus (50) and a second apparatus (70) in a wireless local area network. A second apparatus (70) comprising means (710) configured for: performing a first authentication procedure between a first apparatus (50) and the second apparatus (70) in a wireless local area network. A first identification information of the first apparatus (50) is assigned during the first authentication procedure. According to embodiments of the present disclosure, an improved manner for device identification in wireless local area network may be provided. An identification information of an apparatus may be assigned during an authentication procedure. Thus, in some scenarios, an unidentified apparatus may be further avoided.

### TECHNICAL FIELD

Various example embodiments relate generally to the technology of communication, and in particular to a method and an apparatus for device identification in wireless local area network.

### BACKGROUND

This section introduces aspects that may facilitate better understanding of the present disclosure. Accordingly, the statements of this section are to be read in this light and are not to be understood as admissions about what is in the prior art or what is not in the prior art.

In a wireless communication network (such as in a wireless local area network), a communication apparatus (such as a non-AP station, STA) may access the network via another communication apparatus (such as an access point, AP), so as to obtain various service.

In some scenario, an identification of the communication apparatus is needed. For example, a 4-way handshake may be utilized to identify the STA. However, some STA (such as an un-associated STA) in some procedure (such as FTM procedure) never moves into 4-way handshake, therefore never participates in the identification procedure. Consequently, such un-associated STA is never identified by the network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Certain aspects of the present disclosure and their embodiments may provide solutions to these or other challenges. There are, proposed herein, various embodiments which address one or more of the issues disclosed herein. Specific apparatus and method for device identification in wireless local area network may be provided, so as to identify STA in wireless network.

A first apparatus comprising means configured for: performing a first authentication procedure between the first apparatus and a second apparatus in a wireless local area network. A first identification information of the first apparatus is assigned during the first authentication procedure.

In exemplary embodiments of the present disclosure, the first identification information comprises an identification information element, IE, indicating: a first identifier, ID, of the first apparatus, or a first random media access control address, RMA, of the first apparatus.

In exemplary embodiments of the present disclosure, the first authentication procedure performed by the first apparatus comprises: transmitting, to the second apparatus, a first message of the first authentication procedure; receiving, from the second apparatus, a second message of the first authentication procedure; and transmitting, to the second apparatus, a third message of the first authentication procedure.

In exemplary embodiments of the present disclosure, the first identification information of the first apparatus is assigned by the second apparatus; and the first apparatus receives, from the second apparatus, the first identification information of the first apparatus in the second message of the first authentication procedure, or at least one parameter to generate the first identification information based on predefined equation.

In exemplary embodiments of the present disclosure, the first identification information of the first apparatus is assigned by the first apparatus.

In exemplary embodiments of the present disclosure, the first apparatus transmits, to the second apparatus, the first identification information of the first apparatus in the first or third message of the first authentication procedure; or the first apparatus transmits, to the second apparatus, one or more parameters for the first apparatus and the second apparatus to generate the same first identification information based on predefined equation.

In exemplary embodiments of the present disclosure, the first apparatus further performs a second authentication procedure between the first apparatus and the second apparatus.

In exemplary embodiments of the present disclosure, the first apparatus transmits, to the second apparatus, a first message of the second authentication procedure including the first identification information of the first apparatus; and/or the first apparatus transmits, to the second apparatus, a third message of the second authentication procedure including the first identification information of the first apparatus.

In exemplary embodiments of the present disclosure, the first apparatus receives, from the second apparatus, a second message of the second authentication procedure including a second identification information, or at least one parameter to generate the second identification information based on predefined equation; or the first apparatus transmits, to the second apparatus, the first or third message of the second authentication procedure including the second identification information.

In exemplary embodiments of the present disclosure, the second message of the second authentication procedure further includes a status code to indicate a success or a failure of an identification of the first apparatus.

In exemplary embodiments of the present disclosure, the wireless local area network operates according to a standard of 802.11; the first apparatus comprises a non-AP station, STA; the second apparatus comprises an access point, AP; and the first apparatus is un-associated with the second apparatus.

In exemplary embodiments of the present disclosure, the second apparatus is a first AP in an Extended Service Set, ESS; and the ESS further comprises a second AP and a third AP.

In exemplary embodiments of the present disclosure, the first apparatus uses the first or second identification information in a third authentication procedure between the first apparatus and the second AP; and the first apparatus uses the first or second identification information in a fourth authentication procedure between the first apparatus and the third AP.

In exemplary embodiments of the present disclosure, the first apparatus uses the first or second identification information in a third authentication procedure between the first apparatus and the second AP; and the first apparatus obtains a third identification information in the third authentication procedure between the first apparatus and the second AP; and the first apparatus uses the third identification information in a fourth authentication procedure between the first apparatus and the third AP.

In exemplary embodiments of the present disclosure, the first identification information, and a fourth identification information of the first apparatus are assigned during the first authentication procedure; the first apparatus uses the first identification information in a third authentication procedure between the first apparatus and the second AP; and the first apparatus uses the fourth identification information in a fourth authentication procedure between the first apparatus and the third AP.

In exemplary embodiments of the present disclosure, the means comprises: at least one processor; and at least one memory storing instructions that, when executed by the at least one processor, cause the performance of the first apparatus.

A second aspect of the present disclosure provides a method performed by a first apparatus, comprising: performing a first authentication procedure between the first apparatus and a second apparatus in a wireless local area network. A first identification information of the first apparatus is assigned during the first authentication procedure.

In exemplary embodiments of the present disclosure, the method is performed by the first apparatus according to any of the exemplary embodiments of the first aspect of the present disclosure.

A third aspect of the present disclosure provides a second apparatus comprising means configured for: performing a first authentication procedure between a first apparatus and the second apparatus in a wireless local area network. A first identification information of the first apparatus is assigned during the first authentication procedure.

In exemplary embodiments of the present disclosure, the first identification information comprises an identification information element, IE, indicating a first identifier, ID, of the first apparatus, or a first random media access control address, RMA, of the first apparatus.

In exemplary embodiments of the present disclosure, the first authentication procedure performed by the second apparatus comprises: receiving, from the first apparatus, a first message of the first authentication procedure; transmitting, to the first apparatus, a second message of the first authentication procedure; and receiving, from the first apparatus, a third message of the first authentication procedure.

In exemplary embodiments of the present disclosure, the first identification information of the first apparatus is assigned by the second apparatus; and the second apparatus transmits, to the first apparatus, the first identification information of the first apparatus in the second message of the first authentication procedure, or at least one parameter to generate the first identification information based on predefined equation.

In exemplary embodiments of the present disclosure, the first identification information of the first apparatus is assigned by the first apparatus.

In exemplary embodiments of the present disclosure, the second apparatus receives, from the first apparatus, the first identification information of the first apparatus in the first or third message of the first authentication procedure; or the second apparatus receives, from the first apparatus, one or more parameters for the first apparatus and the second apparatus to generate the same first identification information based on a predefined equation.

In exemplary embodiments of the present disclosure, the second apparatus further performs a second authentication procedure between the first apparatus and the second apparatus.

In exemplary embodiments of the present disclosure, the second apparatus receives, from the first apparatus, a first message of the second authentication procedure including the first identification information of the first apparatus; and/or the second apparatus receives, from the first apparatus, a third message of the second authentication procedure including the first identification information of the first apparatus.

In exemplary embodiments, the first identification information may include a first RMA and/or a first ID. The first RMA shall be the same in the first message and third message. The first ID can be carried in the first message or third message for identification.

In exemplary embodiments of the present disclosure, the second apparatus transmits, to the first apparatus, a second message of the second authentication procedure including a second identification information, or at least one parameter to generate the second identification information based on predefined equation; or the second apparatus receives, from the first apparatus, the first or third message of the second authentication procedure including the second identification information.

In exemplary embodiments of the present disclosure, the second message of the second authentication procedure further includes a status code to indicate a success or a failure of an identification of the first apparatus.

In exemplary embodiments of the present disclosure, the wireless local area network operates according to a standard of 802.11; the first apparatus comprises a non-AP station, STA; the second apparatus comprises an access point, AP; and the first apparatus is un-associated with the second apparatus.

In exemplary embodiments of the present disclosure, the second apparatus is a first AP in an Extended Service Set, ESS; and the ESS further comprises a second AP and a third AP.

In exemplary embodiments of the present disclosure, the first apparatus uses the first or second identification information in a third authentication procedure between the first apparatus and the second AP; and the first apparatus uses the first or second identification information in a fourth authentication procedure between the first apparatus and the third AP.

In exemplary embodiments of the present disclosure, the first apparatus uses the first or second identification information in a third authentication procedure between the first apparatus and the second AP; and the first apparatus obtains a third identification information in the third authentication procedure between the first apparatus and the second AP; and the first apparatus uses the third identification information in a fourth authentication procedure between the first apparatus and the third AP.

In exemplary embodiments of the present disclosure, the first identification information, and a fourth identification information of the first apparatus are assigned during the first authentication procedure; the first apparatus uses the first identification information in a third authentication procedure between the first apparatus and the second AP; and the first apparatus uses the fourth identification information in a fourth authentication procedure between the first apparatus and the third AP.

In exemplary embodiments of the present disclosure, the means comprises: at least one processor; and at least one memory storing instructions that, when executed by the at least one processor, cause the performance of the second apparatus.

A fourth aspect of the present disclosure provides a method performed by a second apparatus, comprising: performing a first authentication procedure between a first apparatus and the second apparatus in a wireless local area network; a first identification information of the first apparatus is assigned during the first authentication procedure.

In exemplary embodiments of the present disclosure, the method is performed by the second apparatus according to any of the exemplary embodiments of the third aspect of the present disclosure.

A fifth aspect of the present disclosure provides a computer-readable storage medium storing instructions, which when executed by at least one processor of a first apparatus, cause the at least one processor of the first apparatus to perform a first authentication procedure between the first apparatus and a second apparatus in a wireless local area network; or when executed by at least one processor of a second apparatus, cause the at least one processor of the second apparatus to perform a first authentication procedure between the first apparatus and a second apparatus in a wireless local area network. A first identification information of the first apparatus is assigned during the first authentication procedure.

In exemplary embodiments of the present disclosure, the instructions are executed by at least one processor of the first apparatus above mentioned; or the instructions are executed by at least one processor of the second apparatus above mentioned.

Embodiments herein afford many advantages. According to embodiments of the present disclosure, an improved manner for device identification in wireless local area network may be provided. An identification information of an apparatus may be assigned during an authentication procedure. Thus, in some scenarios, an unidentified apparatus may be further avoided.

For example, an un-associated STA without 4-way handshake may be also identified.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram showing Current frame exchanges for key generation (PMK and PTK) in 802.11 standard.

FIG. 2 is a diagram showing general signaling flow of 802.11bh proposals.

FIG. 3a is a diagram showing FTM and PASN procedure for associated STA.

FIG. 3b is a diagram showing FTM and PASN procedure for un-associated STA.

FIG. 4 is a diagram showing Identification problem for un-associated STA in FTM procedure: Lack of 4-way handshake causes identification exchange failure.

FIG. 5 is a block diagram showing an exemplary structure for the first apparatus, according to exemplary embodiments of the present disclosure.

FIG. 6a is a flow chart illustrating a method performed by the first apparatus, in accordance with some embodiments of the present disclosure.

FIG. 6b is a flow chart illustrating substeps of the method performed by the first apparatus, in accordance with some embodiments of the present disclosure.

FIG. 7 is a block diagram showing an exemplary structure for the second apparatus, according to exemplary embodiments of the present disclosure.

FIG. 8a is a flow chart illustrating a method performed by the second apparatus, in accordance with some embodiments of the present disclosure.

FIG. 8b is a flow chart illustrating substeps of the method performed by the second apparatus, in accordance with some embodiments of the present disclosure.

FIG. 9 is a block diagram showing an apparatus/computer readable storage medium, according to embodiments of the present disclosure.

FIG. 10a is a block diagram showing exemplary apparatus units for the first apparatus, which is suitable for performing the method according to embodiments of the disclosure.

FIG. 10b is a block diagram showing exemplary apparatus units for the second apparatus, which is suitable for performing the method according to embodiments of the disclosure.

FIG. 11a is a diagram illustrating the general idea how to realize identification procedure for an un-associated STA (using RMA) in FTM procedure for Network initiated identification (category 1).

FIG. 11b is a diagram illustrating the general idea how to realize identification procedure for an un-associated STA (using RMA) in FTM procedure for STA initiated identification (category 2).

FIG. 12 is a diagram summarizing identification procedures categories and authentication frames at which an un-associated STA is identified.

FIG. 13 is a diagram showing a proposed exchange sequence between AP and STA for identifying un-associated STA in FTM for Network Assigned ID, according to exemplary embodiments.

FIG. 14 is a diagram showing a proposed exchange sequence between AP and STA for identifying un-associated STA in FTM for Network Assigned RMA, according to exemplary embodiments.

FIG. 15 is a diagram showing a proposed exchange sequence between AP and STA for identifying un-associated STA in FTM for STA Assigned ID, according to exemplary embodiments.

FIG. 16 is a diagram showing a proposed exchange sequence between AP and STA for identifying un-associated STA in FTM for STA Assigned RMA, according to exemplary embodiments.

FIG. 17a is a diagram showing proposed Information Element order in Authentication Frame, according to embodiments of the present disclosure.

FIG. 17b is a diagram showing proposed Information Element Definition, according to embodiments of the present disclosure.

FIG. 17c is a diagram showing proposed Identification Info Element Format, according to embodiments of the present disclosure.

FIG. 18 is a diagram showing proposed Status Info in Status Code field in Authentication Frame, according to embodiments of the present disclosure.

FIG. 19 is a diagram showing Proposed Status Info incorporated into Identification Info in Authentication Frame, according to embodiments of the present disclosure.

FIG. 20 is a diagram showing Multiple FTM sessions, in which the STA establishes multiple FTM sessions with APs in the same ESS.

FIG. 21 is a diagram showing an example of single-identification usage for multi-session FTM, according to embodiments of the present disclosure.

FIG. 22 is a diagram showing an example of multiple-identification usage for multi-session FTM, according to embodiments of the present disclosure.

### DETAILED DESCRIPTION

The embodiments of the present disclosure are described in detail with reference to the accompanying drawings. It should be understood that these embodiments are discussed only for better understand, rather than limitations on the scope of the present disclosure. The described features, advantages, and characteristics of the disclosure may be combined in any suitable manner in one or more embodiments.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless clearly given and/or implied from the context. Any feature of any of the embodiments disclosed herein may be applied to any other embodiment, wherever appropriate.

As used herein, the term “network” or “communication network” refers to a network following any suitable communication standards (such for an internet network, or any wireless network). For example, wireless communication standards may comprise WLAN, new radio (NR), long term evolution (LTE), LTE-Advanced, etc. In the following description, the terms “network” and “system” can be used interchangeably.

The term “communication apparatus” refers to any end device that can access a communication network and receive services therefrom. By way of example and not limitation, the communication apparatus refers to a mobile terminal, user equipment (UE), or other suitable devices. The communication apparatus may include, but not limited to, a mobile phone, a cellular phone, a smart phone, a wearable device, a vehicle-mounted wireless terminal device, a vehicle, and the like.

As one example, a communication apparatus may represent a device configured for communication in accordance with one or more communication standards promulgated by the Institute of Electrical an Electronics Engineers, IEEE, such as any 802.11 standard, or promulgated by any other organization, such as 3^{rd} generation partnership project, 3GPP.

As yet another example, in an Internet of Things (IoT) scenario, a communication apparatus may represent a machine or other device that performs monitoring and/or measurements, and transmits the results of such monitoring and/or measurements to another terminal device and/or network equipment. Particular examples of such machines or devices are sensors, metering devices such as power meters, industrial machinery, or home or personal appliances, for example refrigerators, televisions, personal wearables such as watches etc. In other scenarios, a communication apparatus may represent a vehicle or other equipment that is capable of monitoring and/or reporting on its operational status or other functions associated with its operation.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

An application scenario in an 802.11 network will be illustrated below, only as one example without limitation.

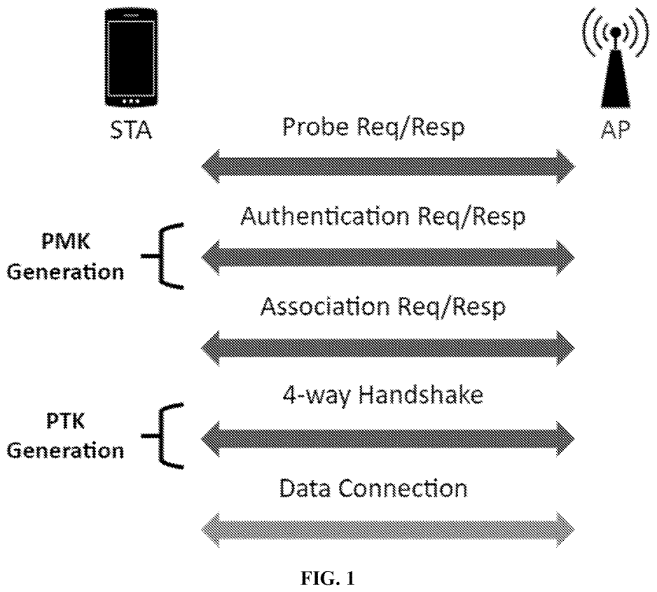

FIG. 1 is a diagram showing Current frame exchanges for key generation (PMK and PTK) in 802.11 standard.

As shown in FIG. 1, PMK (Pairwise Master Key) is generated in Authentication exchange, PTK (Pairwise Transient Key) is generated in 4-way Handshake.

The STA may communicate with the AP via probe request and response (Req/Resp).

Then, STA may communicate with the AP via Authentication request and response, and the PMK is generated.

STA may communicate with the AP via Association request and response.

STA may communicate with the AP via 4-way Handshake, and the PTK is generated.

Finally, data connection between the STA and AP will be established.

Current 802.11 standard requires to generate security keys (such as PMK and PTK) in specific frame exchanges. Strictly speaking, PMK is generated in Authentication frame exchange, and PTK is generated in 4-way Handshake as shown in FIG. 1. Recall that PTK is derived from PMK (along with other parameters). If the keys generation is successful (i.e., keys are verified at both STA (station) and AP (access point)), the STA and AP can start data communication between each other.

802.11bh and 802.11az working groups are relevant within the context of embodiments of the present disclosure, mainly including following.

Firstly, 802.11bh working group focuses on STA using a Randomized and Changing MAC (media access control), RCM, and still being identified by the network. [22/0296r8] and [22/888r2] introduce several proposals for RCM. Vast majority of these proposals take advantage of assigning an ID (identifier)/a random MAC address in 4-way Handshake. Specifically, there are four strong candidate solutions, namely:
a. Network generated device ID (NGID) [22/187r2], where AP generates and assigns a unique ID (called device ID) to the STA in 4-way handshake, and the STA uses that device ID in the subsequent associations. Note that this solution is already in 802.11bh documents, such as 802.11bh draft (D0.2).
b. MAAD (MAC Address Designation) [22/925r2], where AP generates and assigns a unique Random MAC Address (RMA) to the STA in 4-way handshake, and the STA uses that RMA in the subsequent association.
c. IRMA (Identifiable Random MAC Address) [22/895r1], where STA generates and assigns a unique Random MAC Address (RMA) to the STA in 4-way handshake, and the STA uses that RMA in the subsequent association.
d. RRCM (Rule-based Random and Changing MAC Address) [22/888r2], where STA and AP share some parameters so that both sides (STA and AP) generate the same RMA, which will be used in the subsequent association.

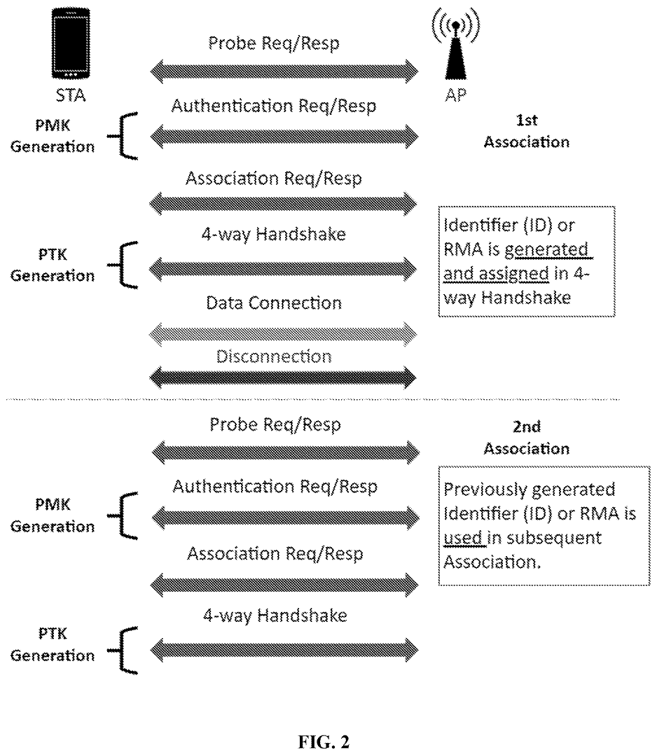

FIG. 2 is a diagram showing general signalling flow of 802.11bh proposals.

As shown in FIG. 2, during a first association, in addition to illustration of FIG. 1, an identifier (ID) or RMA is generated and assigned in 4-way handshake.

Data connection between the STA and AP may be established, and then disconnected.

In a second association, previously generated identifier (ID) or RMA may be further used. The PMK generation shall be in authentication request/response frame exchange, and PTK generation shall be in 4-way handshake in each association.

Secondly, 802.11az focuses on determining absolute and relative position of the STA. In order to achieve that, 802.11az utilizes Fine Timing Measurement (FTM) procedure, where a STA determines its range, relative range and its direction to or from another STA using Time of Flight (TOF) time difference of arrival and phase measurement. FTM procedure is actualized with FTM frames (action frames). Moreover, 802.11az also defines a mechanism called Pre association security negotiation (PASN). Unlike conventional 802.11 standard where PMK is generated in Authentication frame exchange and PTK is generated in 4-way Handshake, PASN generates both PMK and PTK in authentication frame exchanges. Furthermore, FTM procedure is defined for both associated STA and un-associated STA.

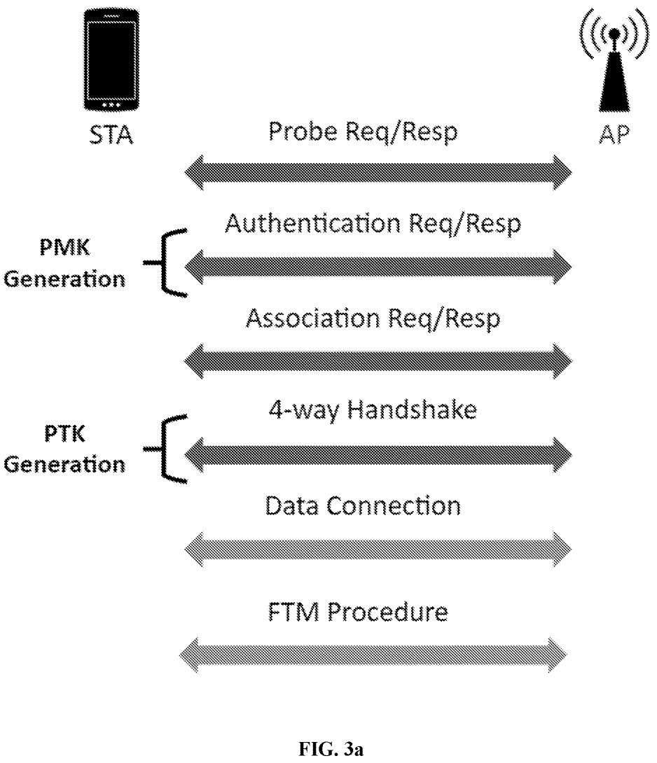

FIG. 3a is a diagram showing FTM and PASN procedure for associated STA. FIG. 3b is a diagram showing FTM and PASN procedure for un-associated STA.

It should be noted that STA can establish multiple FTM sessions with different APs in the same ESS (Extended Service Set).

As shown in FIG. 3a, PASN generates PMK in authentication frame exchanges. Then, STA may communicate with the AP via 4-way Handshake, and PTK may be generated. Then, data connection may be established. Finally, FTM procedure may be performed.

If the STA intends to associate with the AP to have data frame exchange as well as FTM frame exchange, the STA may set up wireless connection following the frame exchange shown in FIG. 1.

As shown in FIG. 3b, PASN generates both PMK and PTK in authentication frame exchanges. Then, FTM procedure may be performed, without association and 4-way handshake procedures.

In conventional PMK and PTK generation, PMK is generated in authentication frame exchange, PTK is generated in 4-way Handshake.

In the general idea of 802.11bh RCM solutions, an identifier or RMA is generated/assigned in 4-way Handshake and that generated ID or RMA will be used by the STA in the subsequent association.

In PASN, both PMK and PTK are generated in authentication frame exchange (as opposed to conventional PMK and PTK generation).

In FTM procedure, FTM frame exchanges (to determine the STA location) can take place for associated STA (STA completes association with AP) and/or un-associated STA (STA does not associate with AP).

The current 802.11bh proposals all follow a similar logic: the STA should send authentication and association frames first, then moves into 4-way handshake for ID/RMA generation and assignment. In the subsequent association, the generated/assigned ID/RMA will be used by the STA again. This procedure requires STA to be associated with the AP each time. If the STA does not associate with the AP, the procedure breaks down. As a relevant scenario, FTM procedure for un-associated STA (see FIG. 3b) can be taken as an example. In this scenario, STA never associates with the AP (note that STA only sends authentication and FTM frames). Since STA never associates with the AP, STA will never get ID or RMA (because STA never moves into 4-way handshake as 802.11bh solutions propose). Because the STA never gets ID/RMA, the identification procedure can't happen. In other words, since un-associated STA in FTM procedure will never moves into 4-way handshake, the STA can't utilize the relevant identification procedure 802.11bh solutions propose, and the STA will never be identified when using RMA.

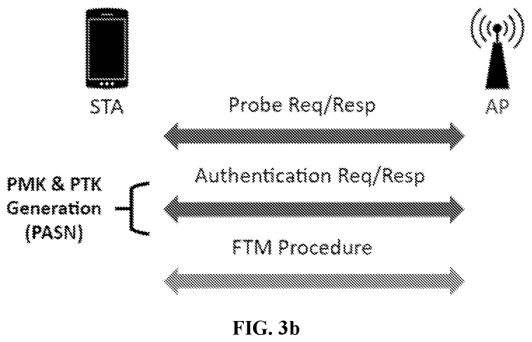

FIG. 4 is a diagram showing Identification problem for un-associated STA in FTM procedure: Lack of 4-way handshake causes identification failure.

In FIG. 4, the STA uses RMA1 in authentication frames, then starts FTM procedure with RMA1. After a while, STA changes its random MAC (i.e., RMA2), and wants to re-start FTM procedure with RMA2. Since the identification procedure never takes places (because the un-associated STA never moves into 4-way handshake, where current 802.11bh solutions realize the identification procedure), the STA is never identified.

The lacked procedures for association and 4-way handshake are shown in dashed lines in FIG. 4.

As discussed above, the proposed identification procedures (generating and assigning ID or RMA) of 802.11bh (STA using random MAC and being identified by the network) happen in 4-way handshake. However, un-associated STA in FTM procedure never moves into 4-way handshake, therefore never participates in the identification procedure. Consequently, un-associated STA in FTM procedure is never identified by the network.

To overcome this problem, embodiments of the present disclosure suggest to take advantage of authentication frame exchanges (such as in PASN) to generate and assign ID/RMA. By realizing the identification procedure in authentication frame exchange, the un-associated STA can be identified by the network.

Furthermore, an un-associated STA can establish multiple FTM procedures (called multi session FTM) with different APs in the same ESS (Extended Service Set). Embodiments of the present disclosure also address this scenario.

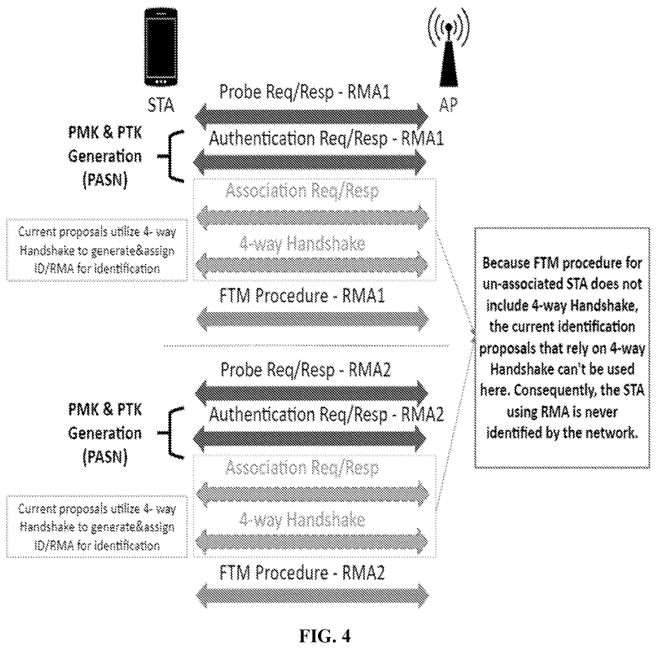

FIG. 5 is a block diagram showing an exemplary structure for the first apparatus, according to exemplary embodiments of the present disclosure.

As shown in FIG. 5, a first apparatus 50 comprises means 510 configured for: performing a first authentication procedure between the first apparatus 50 and a second apparatus in a wireless local area network. A first identification information of the first apparatus 50 is assigned during the first authentication procedure.

According to embodiments of the present disclosure, an improved manner for device identification in wireless local area network may be provided. An identification information of an apparatus may be assigned during an authentication procedure. Thus, in some scenarios, an unidentified apparatus may be further avoided. For example, an un-associated STA without 4-way handshake may be also identified.

In exemplary embodiments of the present disclosure, the first identification information comprises an identification information element, IE, indicating: a first identifier, ID, of the first apparatus 50, or a first random media access control address, RMA, of the first apparatus 50.

In exemplary embodiments of the present disclosure, the first authentication procedure performed by the first apparatus 50 comprises: transmitting, to the second apparatus, a first message of the first authentication procedure; receiving, from the second apparatus, a second message of the first authentication procedure; and transmitting, to the second apparatus, a third message of the first authentication procedure.

In exemplary embodiments of the present disclosure, the first identification information of the first apparatus 50 is assigned by the second apparatus; and the first apparatus 50 receives, from the second apparatus, the first identification information of the first apparatus 50 in the second message of the first authentication procedure, or at least one parameter to generate the first identification information based on predefined equation.

In exemplary embodiments of the present disclosure, the first identification information of the first apparatus 50 is assigned by the first apparatus 50.

In exemplary embodiments of the present disclosure, the first apparatus 50 transmits, to the second apparatus, the first identification information of the first apparatus 50 in the first or third message of the first authentication procedure; or the first apparatus 50 transmits, to the second apparatus, one or more parameters for the first apparatus 50 and the second apparatus to generate the same first identification information based on predefined equation.

In exemplary embodiments of the present disclosure, the first apparatus 50 further performs a second authentication procedure between the first apparatus 50 and the second apparatus.

In exemplary embodiments of the present disclosure, the first apparatus 50 transmits, to the second apparatus, a first message of the second authentication procedure including the first identification information of the first apparatus 50; and/or the first apparatus 50 transmits, to the second apparatus, a third message of the second authentication procedure including the first identification information of the first apparatus 50.

In exemplary embodiments of the present disclosure, the first apparatus 50 receives, from the second apparatus, a second message of the second authentication procedure including a second identification information, or at least one parameter to generate the second identification information based on predefined equation; or the first apparatus 50 transmits, to the second apparatus, the first or third message of the second authentication procedure including a second identification information.

In exemplary embodiments of the present disclosure, the second message of the second authentication procedure further includes a status code to indicate a success or a failure of an identification of the first apparatus 50.

In exemplary embodiments of the present disclosure, the wireless local area network operates according to a standard of 802.11; the first apparatus 50 comprises a non-AP station, STA; the second apparatus comprises an access point, AP; and the first apparatus 50 is un-associated with the second apparatus.

In exemplary embodiments of the present disclosure, the second apparatus is a first AP in an Extended Service Set, ESS; and the ESS further comprises a second AP and a third AP.

In exemplary embodiments of the present disclosure, the first apparatus 50 uses the first or second identification information in a third authentication procedure between the first apparatus 50 and the second AP; and the first apparatus 50 uses the first or second identification information in a fourth authentication procedure between the first apparatus 50 and the third AP.

In exemplary embodiments of the present disclosure, the first apparatus 50 uses the first or second identification information in a third authentication procedure between the first apparatus 50 and the second AP; and the first apparatus 50 obtains a third identification information in the third authentication procedure between the first apparatus 50 and the second AP; and the first apparatus 50 uses the third identification information in a fourth authentication procedure between the first apparatus 50 and the third AP.

In exemplary embodiments of the present disclosure, the first identification information, and a fourth identification information of the first apparatus 50 are assigned during the first authentication procedure; the first apparatus 50 uses the first identification information in a third authentication procedure between the first apparatus 50 and the second AP; and the first apparatus 50 uses the fourth identification information in a fourth authentication procedure between the first apparatus 50 and the third AP.

According to exemplary embodiments of the present disclosure, when multiple authentication procedure take place from un-associated STA, the identification of the STA may be still performed.

In exemplary embodiments of the present disclosure, the means 510 comprises: at least one processor 512; and at least one memory 514 storing instructions that, when executed by the at least one processor 512, cause the performance of the first apparatus 50.

The processor 512 may be any kind of processing component, such as one or more microprocessor or microcontrollers, as well as other digital hardware, which may include digital signal processors (DSPs), special-purpose digital logic, and the like. The memory 514 may be any kind of storage component, such as read-only memory (ROM), random-access memory, cache memory, flash memory devices, optical storage devices, etc.

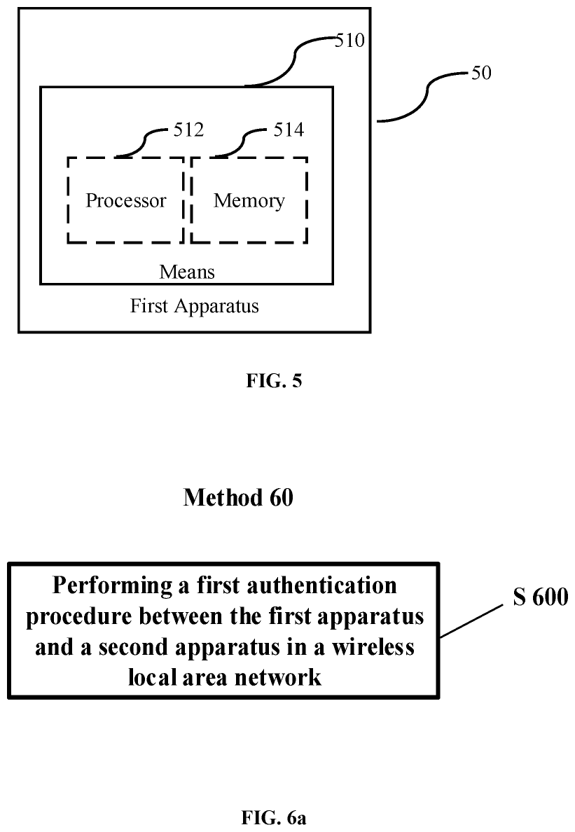

FIG. 6a is a flow chart illustrating a method performed by the first apparatus, in accordance with some embodiments of the present disclosure.

As shown in FIG. 6a, the method 60 performed by a first apparatus 50 may comprises: a step S600, performing a first authentication procedure between the first apparatus 50 and a second apparatus in a wireless local area network. A first identification information of the first apparatus 50 is assigned during the first authentication procedure.

In exemplary embodiments of the present disclosure, the method is performed by the first apparatus 50 above described, such as shown in FIG. 5.

FIG. 6b is a flow chart illustrating substeps of the method performed by the first apparatus, in accordance with some embodiments of the present disclosure.

As shown in FIG. 6b, the first authentication procedure may comprise: a substep S602, transmitting, to the second apparatus, a first message of the first authentication procedure; a substep S604, receiving, from the second apparatus, a second message of the first authentication procedure; and a substep S606, transmitting, to the second apparatus, a third message of the first authentication procedure.

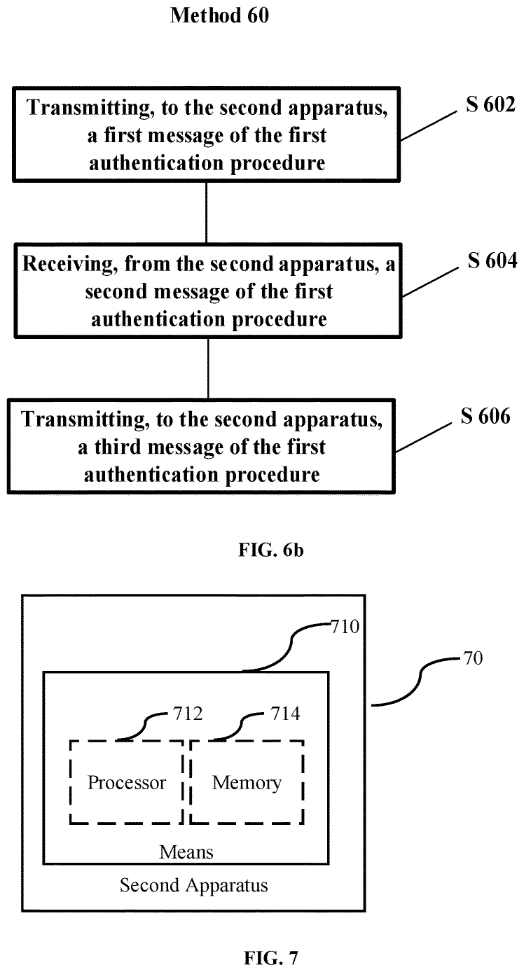

FIG. 7 is a block diagram showing an exemplary structure for the second apparatus, according to exemplary embodiments of the present disclosure.

As shown in FIG. 7, the second apparatus 70 comprises means 710 configured for: performing a first authentication procedure between a first apparatus 50 and the second apparatus 70 in a wireless local area network. A first identification information of the first apparatus 50 is assigned during the first authentication procedure.

In exemplary embodiments of the present disclosure, the first identification information comprises an identification information element, IE, indicating a first identifier, ID, of the first apparatus 50, or a first random media access control address, RMA, of the first apparatus 50.

In exemplary embodiments of the present disclosure, the first authentication procedure performed by the second apparatus 70 comprises: receiving, from the first apparatus 50, a first message of the first authentication procedure; transmitting, to the first apparatus 50, a second message of the first authentication procedure; and receiving, from the first apparatus 50, a third message of the first authentication procedure.

In exemplary embodiments of the present disclosure, the first identification information of the first apparatus 50 is assigned by the second apparatus 70; and the second apparatus 70 transmits, to the first apparatus 50, the first identification information of the first apparatus 50 in the second message of the first authentication procedure, or at least one parameter to generate the first identification information based on predefined equation.

In exemplary embodiments of the present disclosure, the first identification information of the first apparatus 50 is assigned by the first apparatus 50.

In exemplary embodiments of the present disclosure, the second apparatus 70 receives, from the first apparatus 50, the first identification information of the first apparatus 50 in the first or third message of the first authentication procedure; or the second apparatus 70 receives, from the first apparatus 50, one or more parameters for the first apparatus 50 and the second apparatus 70 to generate the same first identification information based on a predefined equation.

In exemplary embodiments of the present disclosure, the second apparatus 70 further performs a second authentication procedure between the first apparatus 50 and the second apparatus 70.

In exemplary embodiments of the present disclosure, the second apparatus 70 receives, from the first apparatus 50, a first message of the second authentication procedure including the first identification information of the first apparatus 50; and/or the second apparatus 70 receives, from the first apparatus 50, a third message of the second authentication procedure including the first identification information of the first apparatus 50.

In exemplary embodiments of the present disclosure, the second apparatus 70 transmits, to the first apparatus 50, a second message of the second authentication procedure including a second identification information, or at least one parameter to generate the second identification information based on predefined equation; or the second apparatus 70 receives, from the first apparatus 50, the first or third message of the second authentication procedure including the second identification information.

In exemplary embodiments of the present disclosure, the second message of the second authentication procedure further includes a status code to indicate a success or a failure of an identification of the first apparatus 50.

In exemplary embodiments of the present disclosure, the wireless local area network operates according to a standard of 802.11; the first apparatus 50 comprises a non-AP station, STA; the second apparatus 70 comprises an access point, AP; and the first apparatus 50 is un-associated with the second apparatus 70.

In exemplary embodiments of the present disclosure, the second apparatus 70 is a first AP in an Extended Service Set, ESS; and the ESS further comprises a second AP and a third AP.

In exemplary embodiments of the present disclosure, the first apparatus 50 uses the first or second identification information in a third authentication procedure between the first apparatus 50 and the second AP; and the first apparatus 50 uses the first or second identification information in a fourth authentication procedure between the first apparatus 50 and the third AP.

In exemplary embodiments of the present disclosure, the first apparatus 50 uses the first identification information in a third authentication procedure between the first apparatus 50 and the second AP; and the first apparatus 50 obtains a third identification information in the third authentication procedure between the first apparatus 50 and the second AP; and the first apparatus 50 uses the third identification information in a fourth authentication procedure between the first apparatus 50 and the third AP.

In exemplary embodiments of the present disclosure, the first identification information, and a fourth identification information of the first apparatus 50 are assigned during the first authentication procedure; the first apparatus 50 uses the first identification information in a third authentication procedure between the first apparatus 50 and the second AP; and the first apparatus 50 uses the fourth identification information in a fourth authentication procedure between the first apparatus 50 and the third AP.

In exemplary embodiments of the present disclosure, the means comprises: at least one processor 712; and at least one memory 714 storing instructions that, when executed by the at least one processor 712, cause the performance of the second apparatus 70.

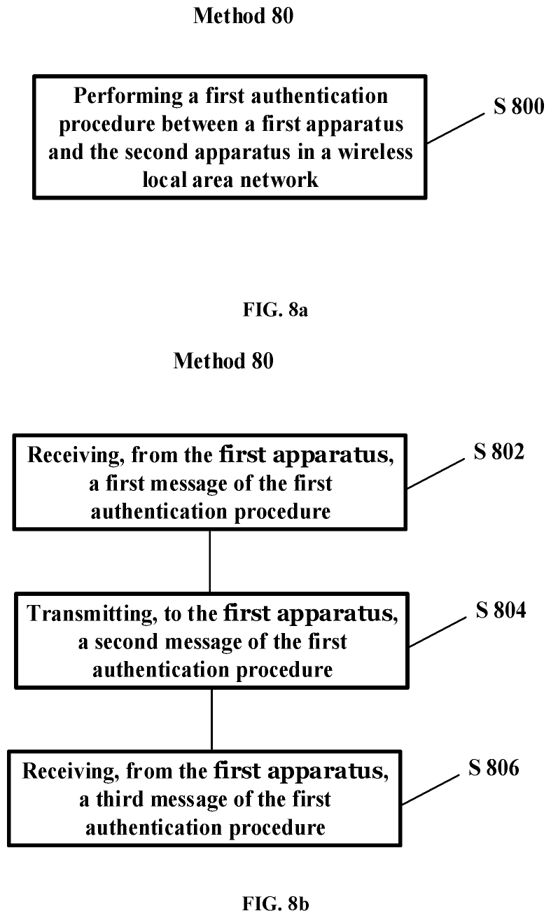

FIG. 8a is a flow chart illustrating a method performed by the second apparatus, in accordance with some embodiments of the present disclosure.

As shown in FIG. 8a, the method 80 performed by a second apparatus 70 comprises: a step S800, performing a first authentication procedure between a first apparatus and the second apparatus 70 in a wireless local area network. A first identification information of the first apparatus is assigned during the first authentication procedure.

In exemplary embodiments of the present disclosure, the method is performed by the second apparatus 70 above described, such as shown in FIG. 7.

FIG. 8b is a flow chart illustrating substeps of the method performed by the second apparatus, in accordance with some embodiments of the present disclosure.

As shown in FIG. 8b, the first authentication procedure may comprise: a substep S802, receiving, from the first apparatus 50, a first message of the first authentication procedure; a substep S804, transmitting, to the first apparatus 50, a second message of the first authentication procedure; and a substep S806, receiving, from the first apparatus 50, a third message of the first authentication procedure.

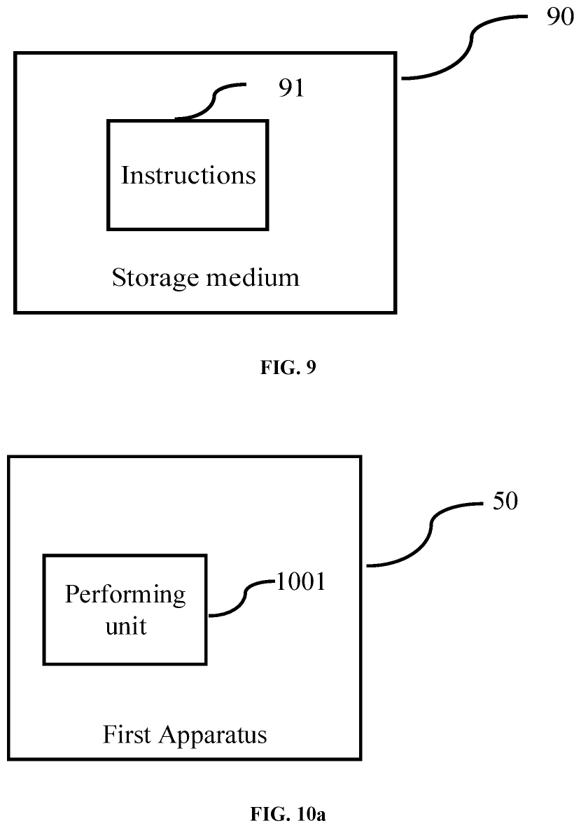

FIG. 9 is a block diagram showing an apparatus/computer readable storage medium, according to embodiments of the present disclosure.

As shown in FIG. 9, the computer-readable storage medium 90 stores instructions 91, which when executed by at least one processor of a first apparatus, cause the at least one processor of the first apparatus 50 to perform a first authentication procedure between the first apparatus 50 and a second apparatus 70 in a wireless local area network; or when executed by at least one processor of a second apparatus 70, cause the at least one processor of the second apparatus 70 to perform a first authentication procedure between the first apparatus and a second apparatus 70 in a wireless local area network. A first identification information of the first apparatus 50 is assigned during the first authentication procedure.

In exemplary embodiments of the present disclosure, the first apparatus 50 are as described above, such as shown in FIG. 5, and the second apparatus 70 are as described above, such as shown in FIG. 7.

In addition, the present disclosure may also provide a carrier containing the computer program/instructions as mentioned above. The carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

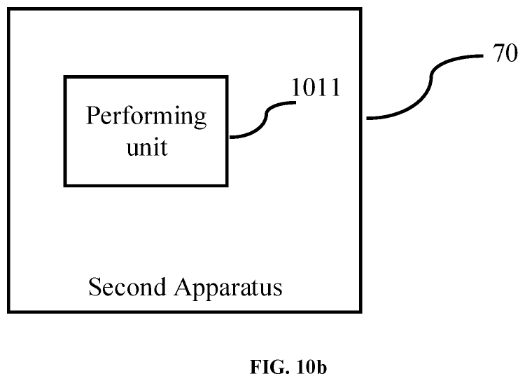

FIG. 10a is a block diagram showing exemplary apparatus units for the first apparatus, which is suitable for performing the method according to embodiments of the disclosure.

As shown in FIG. 10a, the first apparatus 50 may include a performing unit 1001, for performing a first authentication procedure between the first apparatus 50 and the second apparatus 70 in a wireless local area network. A first identification information of the first apparatus is assigned during the first authentication procedure.

FIG. 10b is a block diagram showing exemplary apparatus units for the second apparatus, which is suitable for performing the method according to embodiments of the disclosure.

As shown in FIG. 10b, the second apparatus 70 may include a performing unit 1011, for performing a first authentication procedure between the first apparatus 50 and the second apparatus 70 in a wireless local area network. A first identification information of the first apparatus 50 is assigned during the first authentication procedure.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

As used in the present disclosure, the term “circuitry” may refer to one or more or all of the following:
(a) hardware-only circuit implementations (such as implementations in only analogy and/or digital circuitry) and
(b) combinations of hardware circuits and software, such as (as applicable):
   (i) a combination of analogy and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term “non-transitory,” as used herein, is a limitation of the medium itself (i.e., tangible, not a signal) as opposed to a limitation on data storage persistency (e.g., RAM vs. ROM).

In summary, within this context, the ideas of embodiments of the present disclosure may include following.

The embodiments of the present disclosure propose to utilize authentication frame exchanges in PASN to generate and assign ID/RMA. By doing so, the un-associated STA with RMA can be identified by the network in FTM procedure.

The embodiments of the present disclosure define a feedback mechanism (i.e., status info) to indicate success/failure of the proposed identification method.

The embodiments of the present disclosure also address multi session FTM procedure.

For simplicity of illustrating implementation scenarios, the 802.11bh identification procedures may be divided into two categories:
1—Network initiated identification: This covers the cases, where network (AP) generates and assigns ID to the STA, and where network (AP) generates and assigns RMA to the STA.
2—STA initiated identification: This covers the cases, where STA generates and assigns RMA to the STA, where STA shares the relevant parameters to the AP so that both sides can generate the same RMA, and where STA generates and assigns ID to the STA.

Particularly, in Network initiated identification (category 1): the STA is assigned (by AP) identification info (e.g., RMA or ID) in Authentication Msg2 in first association (authentication), the STA uses identification info (e.g., RMA or ID) in Authentication Msg1 (e.g., RMA or ID) or Authentication Msg3 (e.g., ID) in second association (authentication).

Further, the STA may be assigned (by AP) identification info (e.g., new RMA or ID) in Authentication Msg2 in second association (authentication).

In STA initiated identification (category 2): the STA is assigned (by itself) identification info (e.g., RMA or ID) in Authentication Msg1 or Authentication Msg3 in first association (authentication), the STA uses identification info (e.g., RMA or ID) in Authentication Msg1 (e.g., RMA or ID) or Authentication Msg3 (e.g., ID) in second association.

Further, the STA may be assigned (by itself) identification info (e.g., new RMA or ID) in Authentication Msg1 or Authentication Msg3 in second association (authentication).

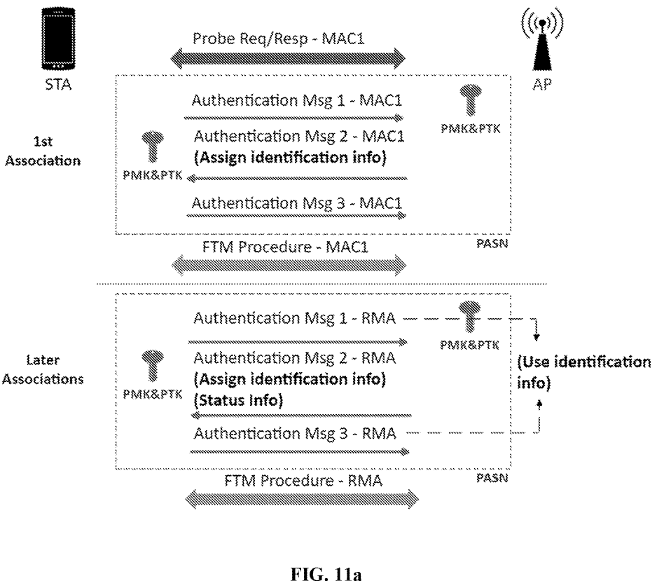

FIG. 11a is a diagram illustrating the general idea how to realize identification procedure for an un-associated STA (using RMA) in FTM procedure for Network initiated identification (category 1). FIG. 11b is a diagram illustrating the general idea how to realize identification procedure for an un-associated STA (using RMA) in FTM procedure for STA initiated identification (category 2).

More specifically, the key steps of the embodiments can be summarized as follows. The STA and AP first negotiate what kind of identification scheme they use (A. Network initiated identification—category 1—, or B. STA initiated identification—category 2—).

As shown in FIG. 11a, for Network initiated identification (category 1), the first Association procedure may include following steps.
1) The un-associated STA first sends Authentication Msg1 to the AP. This message consists of FTM procedure initialization and relevant information for key generation.
2) After AP receives Authentication Msg1, it derives its security keys (PMK and PTK), generates identification information (ID or RMA depending on the identification scheme), encrypts this information in Authentication Msg2 payload as an Information Element (IE), and sends it to the STA. This identification information will be used by the STA in later associations.
3) After STA receives Authentication Msg2, it derives its security keys (the same PMK and PTK), decrypts and obtains the identification information (ID or RMA) for future use.
4) After obtaining identification information, STA sends Authentication Msg3 to finish the authentication procedure and moves into FTM procedure.

Then, any of the later associations may include following steps.
1) STA wants to re-start the FTM procedure with another MAC address; therefore, it first starts the authentication frame exchanges with random MAC (RMA). Since previous association assigned identification information (ID or RMA) to the STA, the STA uses that identification information (ID and/or RMA) in Authentication Msg1 and/or Msg3 as follows.
1.1) If STA uses RMA identification, it uses the RMA information (assigned from previous association) in Authentication Msg1. Hence, in Authentication Msg1, the STA is always identified.
1.2) If STA uses ID identification, it uses the ID information (assigned from previous association) in Authentication Msg1 or Msg3. Hence, in Authentication Msg1 or Msg3, the STA is always identified.
1.3) If STA uses both RMA and ID identification, it uses RMA information (assigned from previous association) in Authentication Msg1 and Msg3, and ID information (assigned from previous association) in Authentication Msg1 or Msg3. Hence, in Authentication Msg1 and/or Authentication Msg3, the STA is always identified.
2) STA always obtains the new identification information (ID or RMA generated and assigned by the AP) in Authentication Msg2. Furthermore, Authentication Msg2 also may include status info to indicate identification success/failure.

Identification information may be encrypted optionally and whenever possible in Authentication Msg1, Msg2, and Msg3.

As shown in FIG. 11b, for STA initiated identification (category 2), the first association procedure may include following steps.
1) The un-associated STA first sends Authentication Msg1 to the AP. This message consists of FTM procedure initialization and relevant information for key generation.
2) After AP receives Authentication Msg1, it derives its security keys (PMK and PTK) accordingly. AP replies with Authentication Msg2.
3) After STA receives Authentication Msg2, it derives the security keys (the same PMK and PTK), generates identification information (ID or RMA depending on the identification scheme), encrypts this information in Authentication Msg3 payload as an Information Element (IE), and sends it to the AP. This identification information will be used by the STA in later associations.
4) AP receives Authentication Msg3, decrypts and obtains the identification information (ID or RMA). The authentication procedure finishes with Authentication Msg3.

Then, any of the later associations may include following steps.
1) STA wants to re-start the FTM procedure with another MAC address; therefore, it first starts the authentication frame exchanges with random MAC (RMA). Since previous association assigned identification information (ID or RMA) to the AP, the STA use that identification information (ID or RMA) in Authentication Msg1 and/or Msg3 as follows.
1.1) If STA uses RMA identification, it uses the RMA information (assigned in previous association) in Authentication Msg1. Hence, in Authentication Msg1, the STA is always identified.
1.2) If STA uses ID identification, it uses the ID information (assigned in previous association) in Authentication Msg3. Hence, in Authentication Msg3, the STA is always identified.
1.3) If STA uses both RMA and ID identification, is uses RMA information (generated in previous association) in Authentication Msg1 and ID information (assigned in previous association) in Authentication Msg3. Hence, in Authentication Msg1 and/or Authentication Msg3, the STA is always identified.
2) Authentication Msg2 may include status info to indicate identification success/failure.
3) STA always assigns the new identification information (ID or RMA generated and assigned by the STA) in Authentication Msg3.

It should be noted that the identification information (including such RMA, ID) can be carried in both MSG 1 and MSG3 in every scenario.

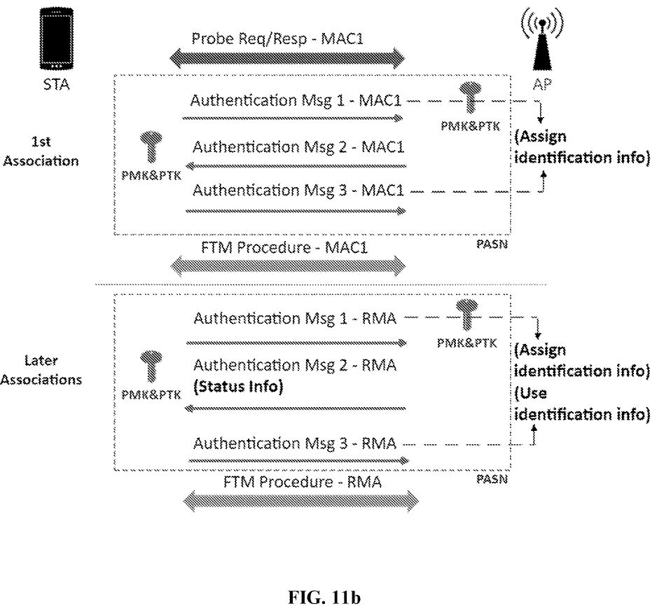

FIG. 12 is a diagram summarizing identification procedures categories and authentication frames at which an un-associated STA is identified.

As shown in FIG. 12, for identification, for either network initiated identification (category 1) or STA initiated identification (category 2), the STA may be identified. For assigned ID, the STA may be identified in Msg1 or Msg3. Or, for assigned RMA, the STA may be identified in Msg1 or Msg3.

Further, for example, in some scenarios, the identification procedure may be named as a random MAC (RMA) identification procedure as shown in FIG. 12, and thus the identification information may be also named as RMA identification information.

Further detailed embodiments for category 1 (Network initiated identification) and category 2 (STA initiated identification) will be illustrated below.

Also, detailed embodiments will further provide details to realize the proposed procedure such as: creating an information element (IE) to carry relevant identification information (ID and RMA) in authentication frames; adding status info to feedback about the identification; addressing where multiple FTM sessions take place from un-associated STA.

The current identification solutions of 802.11bh utilize 4-way Handshake. However, un-associated STA in FTM procedure never moves into 4-way handshake, therefore never participates in the identification procedure. Consequently, un-associated STA in FTM procedure is never identified by the network. Hence, detailed embodiments may provide identification procedure into authentication frame exchange in PASN. Note that PASN utilizes 3 authentication message exchanges. Also note that PASN generates necessary security keys to do encryption in authentication frames (specifically, AP can do encryption for Authentication Msg2, STA can do encryption for Authentication Msg3. In some scenario, authentication Msg1 cannot be encrypted).

By taking advantage of authentication frame exchange for identification, the network (AP) can identify the un-associated STA when the STA uses a random MAC (RMA).

In this context, as explained in accordance with FIG. 11a, 11b, and FIG. 12, the 802.11bh identification procedures may be divided into two categories: 1—Network initiated RMA identification; 2—STA initiated RMA identification

FIG. 11a, 11b and FIG. 12 may be recalled to give a general view of the identification schemes for both categories.

The detailed signaling flow for category 1 and category 2 identification will be illustrated. The necessary information element (IE) to carry identification information (ID and RMA) will be illustrated. Status information to feedback about the identification will be introduced. The multiple FTM sessions by un-associated STA will be also illustrated.

The following embodiments demonstrate the detailed signaling flows for Category 1-Network Assigned ID & Network Assigned RMA, and Category 2-STA Assigned ID & STA Assigned RMA & STA assigned parameter to generate the same RMA.

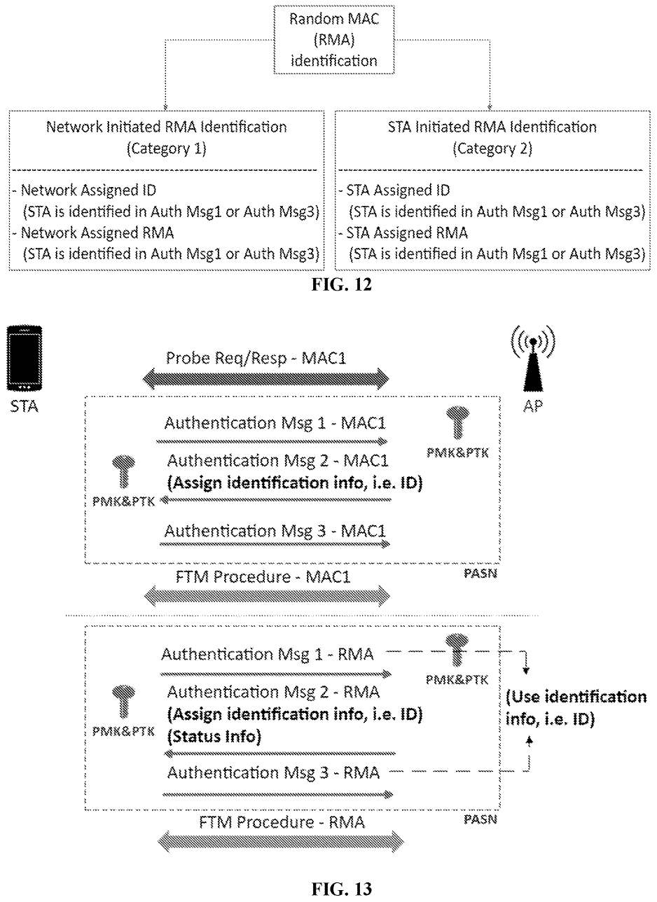

FIG. 13 is a diagram showing a proposed exchange sequence between AP and STA for identifying un-associated STA in FTM for Network Assigned ID, according to exemplary embodiments.

As shown in FIG. 13, this embodiment covers a solution where network (AP) generates and assigns ID to the STA.

The first association includes following steps.
1) The un-associated STA first sends Authentication Msg1 to the AP. This message consists of FTM procedure initialization and relevant information for key generation.
2) After AP receives Authentication Msg1, it derives security keys (PMK and PTK) accordingly. At this point, because AP has the security keys, it can now encrypt Authentication Msg2 payload. Therefore, AP generates identification information (ID), encrypts this information in Authentication Msg2 payload as an Information Element (IE), and sends it to the STA. This ID information will be used by the STA in later associations.
3) After STA receives Authentication Msg2, it derives its security keys (the same PMK and PTK). Here, because STA also has the security keys, it can decrypt the payload of Authentication Msg2. Hence, STA decrypts and obtains the identification information (such as ID) for future use. Note that since only STA and AP have the relevant security keys, only they can decrypt the identification information (no third party can access this information).
4) After obtaining ID information, STA sends Authentication Msg3 to finish the authentication procedure and moves into FTM procedure.

Any of the later association may include following steps.
1) STA wants to re-start the FTM procedure with another MAC address; therefore, it first starts the authentication frame exchanges with random MAC (RMA). Here, the STA uses unidentifiable RMA in its MAC header. Since previous association assigned identification information (ID) to the STA, the STA use that identification information (ID) in Authentication Msg1 or Msg 3. Hence, In Authentication Msg1 or Msg3, the STA is always identified.
2) STA always obtains the new identification information (ID generated and assigned by the AP) in Authentication Msg2.

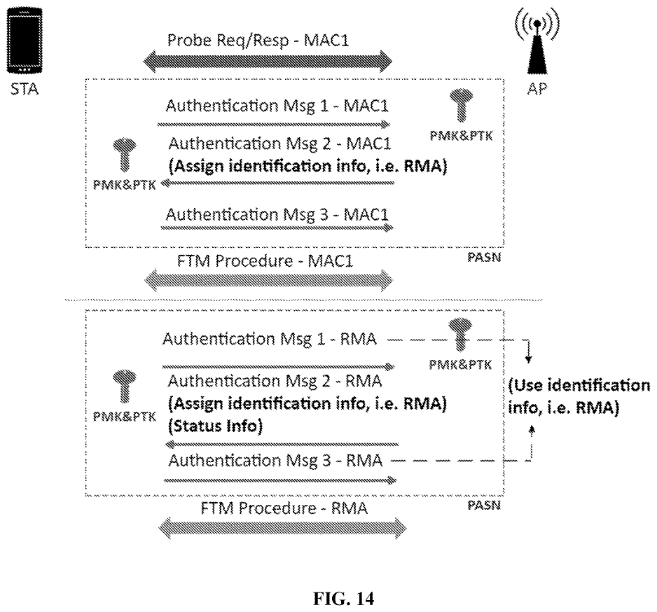

FIG. 14 is a diagram showing a proposed exchange sequence between AP and STA for identifying un-associated STA in FTM for Network Assigned RMA, according to exemplary embodiments.

As shown in FIG. 14, this embodiment covers a solution where network (AP) generates and assigns RMA to the STA.

The first Association may include following steps.
1) The un-associated STA first sends Authentication Msg1 to the AP. This message consists of FTM procedure initialization and relevant information for key generation.
2) After AP receives Authentication Msg1, it derives security keys (PMK and PTK) accordingly. At this point, because AP has the security keys, it can now encrypt Authentication Msg2 payload. Therefore, AP generates identification information (such as RMA), encrypts this information in Authentication Msg2 payload as an Information Element (IE), and sends it to the STA. This RMA information will be used by the STA in later associations.
3) After STA receives Authentication Msg2, it derives its security keys (the same PMK and PTK). Here, because STA also has the security keys, it can decrypt the payload of Authentication Msg2. Hence, STA decrypts and obtains the identification information (RMA) for future use. Note that since only STA and AP have the relevant security keys, only they can decrypt the identification information (no third party can access this information).
4) After obtaining RMA information, STA sends Authentication Msg3 to finish the authentication procedure and moves into FTM procedure.

Any of the later Associations may include following steps.
1) STA wants to re-start the FTM procedure with another MAC address; therefore, it first starts the authentication frame exchanges with random MAC (RMA). Since previous association assigned identification information (RMA) to the STA, the STA use that identification information (RMA) in Authentication Msg1. Note that this identification information (RMA) is an identifiable RMA used in MAC header. Hence, In Authentication Msg1, the STA is always identified. This identification information (RMA) may be also used in Msg3.
2) STA always obtains the new identification information (RMA generated and assigned by the AP) in Authentication Msg2. Furthermore, Authentication Msg2 also may include status info to indicate identification success/failure.

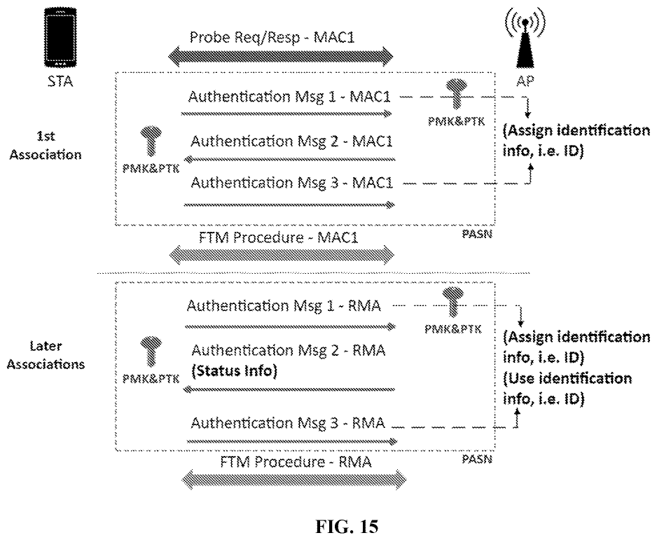

FIG. 15 is a diagram showing a proposed exchange sequence between AP and STA for identifying un-associated STA in FTM for STA Assigned ID, according to exemplary embodiments.

As shown in FIG. 15, this embodiment covers a solution where STA generates and assigns ID to the STA.

The first association may include following steps.
1) The un-associated STA first sends Authentication Msg1 to the AP. This message consists of FTM procedure initialization and relevant information for key generation.
2) After AP receives Authentication Msg1, it derives its security keys (PMK and PTK) accordingly. At this point, because AP has the security keys. AP replies with Authentication Msg2.
3) After STA receives Authentication Msg2, it derives it security keys (the same PMK and PTK). Here, because STA also has the security keys, it can encrypt Authentication Msg3. Therefore, STA generates identification information (ID), encrypts this information in Authentication Msg3 payload as an Information Element (IE), and sends it to the AP. This identification information will be used by the STA in later associations.
4) AP receives Authentication Msg3, decrypts and obtains the identification information (ID). The authentication procedure finishes with Authentication Msg3.

Further, as shown in FIG. 15, the identification information (such as ID) may be also included in the Msg1.

Any of the later associations may include following steps.
1) STA wants to re-start the FTM procedure with another MAC address; therefore, it first starts the authentication frame exchanges with random MAC (RMA). Here, the STA uses unidentifiable RMA in its MAC header. Since previous association assigned identification information (ID) to the AP, the STA may use that identification information (ID) in Authentication Msg1 or Msg3. Hence, In Authentication Msg 1 or Msg3, the STA is always identified.
2) STA always assigns the new identification information (ID or RMA generated and assigned by the STA) in Authentication Msg 1 or Msg3.

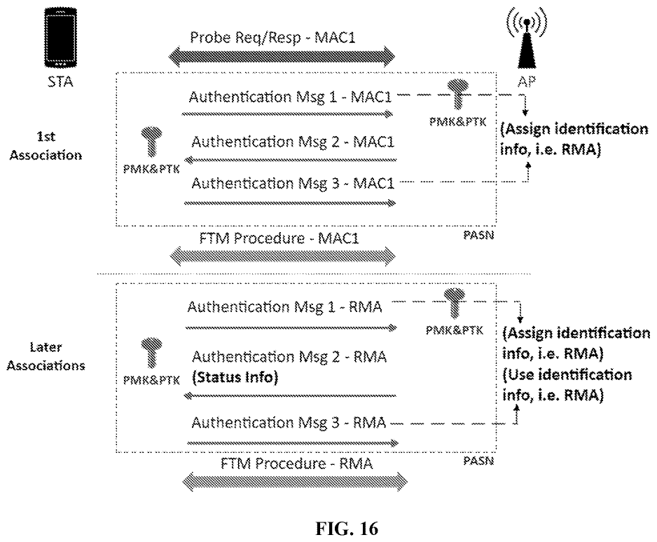

FIG. 16 is a diagram showing a proposed exchange sequence between AP and STA for identifying un-associated STA in FTM for STA Assigned RMA, according to exemplary embodiments.

As shown in FIG. 16, this embodiment covers a solution where network STA generates and assigns RMA to the AP. Note that while IRMA generates the RMA and sends it to the AP, RRCM sends relevant parameters, such as seed, RMA number, timer, predefined equations, private key, public key, private ID, public ID, public MAC address, time information, any additional private/public data, to the AP so that AP and STA can generate the same RMA.

The first association may include following steps.
1) The un-associated STA first sends Authentication Msg1 to the AP. This message consists of FTM procedure initialization and relevant information for key generation.
2) After AP receives Authentication Msg1, it derives its security keys (PMK and PTK) accordingly. At this point, because AP has the security keys. AP replies with Authentication Msg2.
3) After STA receives Authentication Msg2, it derives it security keys (the same PMK and PTK). Here, because STA also has the security keys, it can encrypt Authentication Msg3. Therefore, STA generates identification information (RMA), encrypts this information in Authentication Msg3 payload as an Information Element (IE), and sends it to the AP. This identification information will be used by the STA in later associations.
4) AP receives Authentication Msg3, decrypts and obtains the identification information (RMA). The authentication procedure finishes with Authentication Msg3.

Further, as shown in FIG. 16, the identification information (RMA) may be also included in the Msg1.

Any of the later association may include following steps.
1) STA wants to re-start the FTM procedure with another MAC address; therefore, it first starts the authentication frame exchanges with random MAC (RMA). Since previous association assigned identification information (RMA) to the AP, the STA use that identification information (RMA) in Authentication Msg1. Note that this identification information (RMA) is an identifiable RMA used in MAC header. Hence, In Authentication Msg1, the STA is always identified. This identification information (RMA) may be also used in Msg3.
2) Authentication Msg2 may include status info to indicate identification success/failure.
3) STA always assigns the new identification information (ID or RMA generated and assigned by the STA) in Authentication Msg1 or Msg3.

Proposed Information Element (RMA Identification info) for Authentication Frame to carry identification (ID or RMA) information will be further described below.

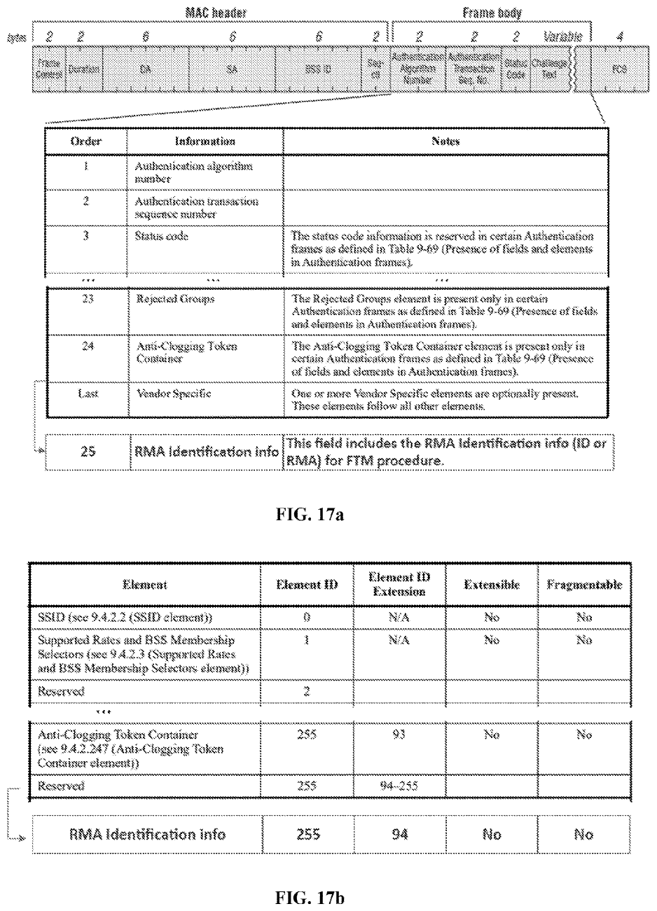

FIG. 17a is a diagram showing proposed Information Element order in Authentication Frame, according to embodiments of the present disclosure.

FIG. 17b is a diagram showing proposed Information Element Definition, according to embodiments of the present disclosure.

FIG. 17c is a diagram showing proposed RMA Identification Info Element Format, according to embodiments of the present disclosure.

As shown FIG. 17a, proposed identification scheme utilizes authentication frame exchanges. Namely, the identification information (ID or RMA) should be put into authentication frames. In order to achieve that, this embodiment proposes an Information Element (IE) in authentication frame body. This IE may be referred as RMA Identification info IE.

The current 802.11REVme_D1.3 defines 24 items in authentication frame body (see table 9.68 in 802.11REVme_D1.3). The proposed Information Element order is Order=25 or other value, as shown in FIG. 17a. This field carries identification information (ID or RMA) for un-associated STA in FTM procedure.

The current 802.11REVme_D1.3 also defines many Information elements (Table 9-128—Element IDs in 802.11REVme_D1.3). The proposed Information Element is Element ID=255, Element ID Extension=94, Extensible=No, Fragmentable=No, as shown in FIG. 17b. The ID can be changed accordingly if some new element ID inserted in 802.11 specification according to practical implementation.

An exemplary format for the proposed RMA identification information element may be: Element, Length, Element ID Extension, RMA Identification information, as shown in FIG. 17c. Septically, the information element may be used for including: 1) Random MAC Address (RMA), and/or 2) ID; and/or 3) parameters to generate the RMA or ID (such as key, MAC, time info, seed, or any other parameter described above).

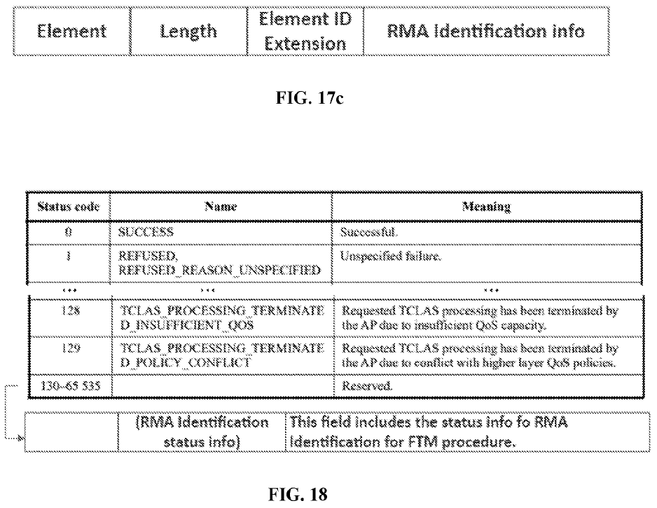

FIG. 18 is a diagram showing proposed Status Info in Status Code field in Authentication Frame, according to embodiments of the present disclosure.

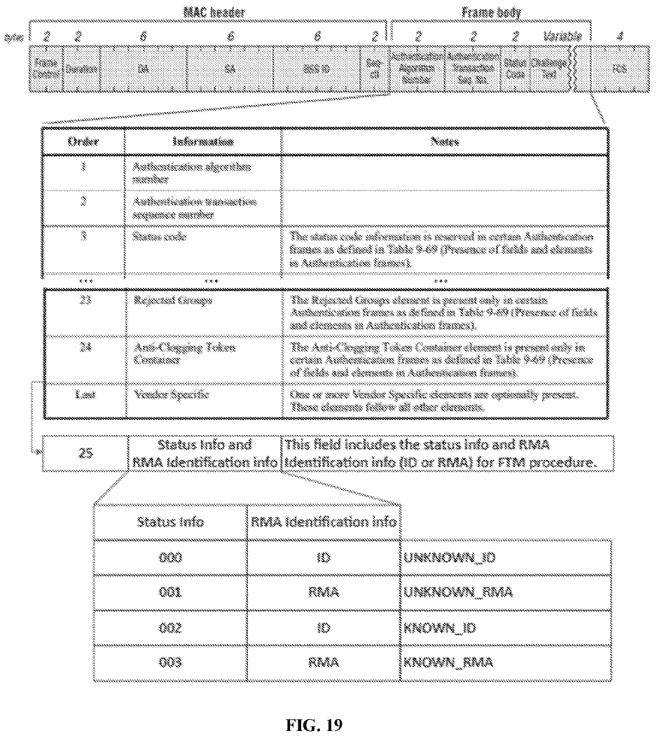

FIG. 19 is a diagram showing Proposed Status Info incorporated into RMA Identification Info in Authentication Frame, according to embodiments of the present disclosure.

This embodiment defines a feedback mechanism for identification procedure. More specifically, the proposed identification mechanism generates and assigns identification information (ID or RMA) from/to STA in authentication frame exchange. However, there is no feedback mechanism to specify the success or failure of the identification procedure. Within this regard, it is proposed to add “status information” to the identification procedure either of two ways: extending the already present Status Code in Authentication Frame (as shown in FIG. 18), extending the “RMA Identification info” field that is defined in Authentication Frame Body (as shown in FIG. 19).

Status Code is already defined for management frames, including Authentication Frames (See FIG. 17a—Order: 3).

The current 802.11REVme_D1.3 defines 129 status code (see table 9.78 in 802.11REVme_D1.3). There are many reserved status code fields that are utilized for the proposed identification procedure. It is proposed to add relevant status information onto this field as shown in FIG. 18.

This field can include several related status info for identification scheme for un-associated STA. As an example, some of these field at least may include the values shown in the following table.

| Status | | |
|---|---|---|
| Code | Name | Meaning |
| 130 | UNKNOWN_ID | The assigned identification information |
| | | (ID) is unknown. |
| 131 | UNKNOWN_RMA | The assigned identification information |
| | | (RMA) is unknown. |
| 132 | KNOWN_ID | The assigned identification information |
| | | (ID) is known. |
| 133 | KNOWN_RMA | The assigned identification information |
| | | (RMA) is known. |

If Status code 130 or 131 is sent, it implies that the identification is failed, If Status Code 132 or 133 is sent, the identification is succeeded.

As shown in FIG. 19, an example of status info bits incorporated into identification Info may be illustrated.

Status information can be incorporated into RMA Identification Info field. Some control bits can be added to the identification information to indicate the status info about the procedure.

If 000 or 001 is sent in Status Info, the identification is failed. If 002 or 003 is sent in Status Info, the identification is succeeded.

It should be noted that other codes, names, meanings may be also configured according to practical implementation.

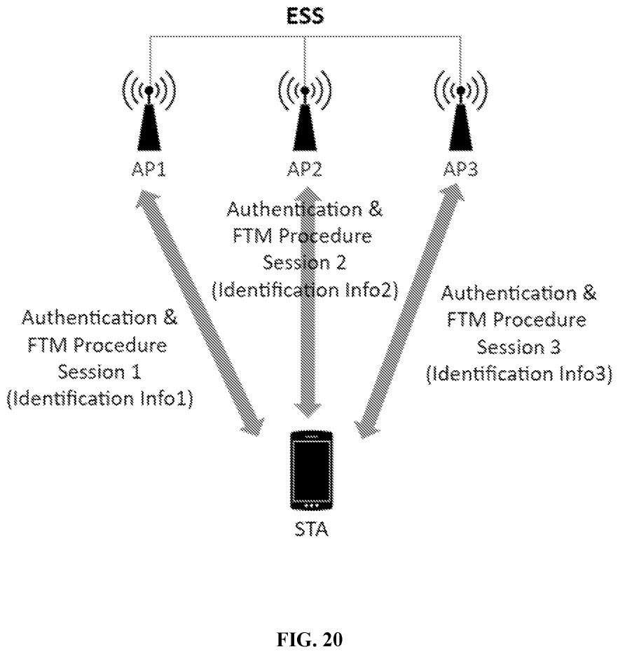

FIG. 20 is a diagram showing Multiple FTM sessions, in which the STA establishes multiple FTM sessions with APs in the same ESS.

As shown in FIG. 20, the example of STA set-up multiple FTM sessions with the same ESS via the usage of different RMAs may be illustrated.

This embodiment addresses identification for multi-session FTM procedure. Multi-session FTM procedure happens when the STA with difference RMAs establishes more than one FTM sessions with multiple APs simultaneously in the same ESS. AP1, AP2, and AP3 may belong to the same ESS.

STA may establish a session 1 with the AP1, a session 2 with AP2, and a session 3 with AP 3.

When establishing multiple FTM session, STA or AP may generate multiple identification information to be used in each session. Single identification information may be used between STA and AP, or multiple identification information may be used between STA and AP.

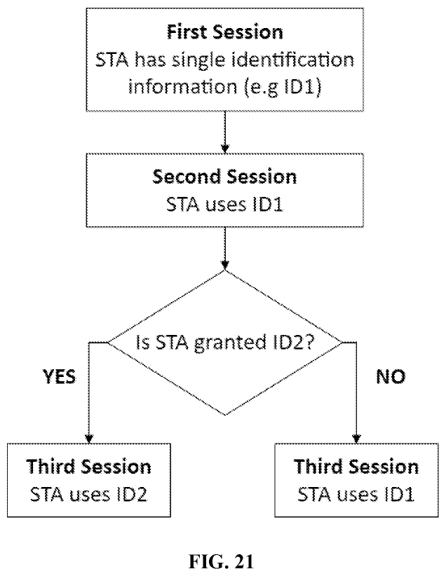

FIG. 21 is a diagram showing an example of single-identification usage for multi-session FTM, according to embodiments of the present disclosure.

As shown in FIG. 21, a method, in which STA and AP set up single identification information, may be illustrated.

To establish first FTM session, The STA first sends authentication request to a specific AP (say AP1) in the ESS. In the authentication frames exchange, the STA sets up single identification information (single ID or single RMA) (ESS grants single identification information to the STA, or the STA grants single identification information to ESS) and starts the FTM procedure.

The STA then starts to establish the second FTM session by sending authentication request to another AP in the ESS (say AP2). During this authentication frames exchanges, the STA uses the identification information granted in the previous authentication frame exchanges from first session.

When STA wants to start another FTM session (e.g., third FTM session with AP3), if the ESS doesn't grant the new identification information to the STA in the second session, or the STA doesn't grant the new identification information in the second session, the STA has to use the same identification (as granted in first session) in the third session. if the ESS grants the new identification information to the STA in the second session, or the STA grants the new identification information in the second session, STA uses the identification granted in second session.

As shown in FIG. 21, in the first FTM session, STA is granted ID1. In the second FTM session, STA uses ID1 (granted from first session). In second session, if new identification information (ID2) is not granted, the STA uses ID1 for third session. If new identification information (ID2) is granted, the STA uses ID2 for third session.

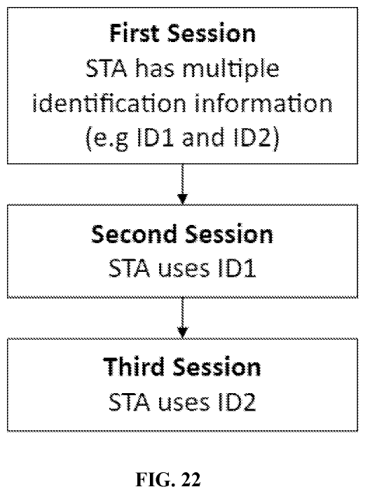

FIG. 22 is a diagram showing an example of multiple-identification usage for multi-session FTM, according to embodiments of the present disclosure.

As shown in FIG. 22, a method, in which STA and AP set up multiple identification information, may be illustrated.

To establish first FTM session, The STA first sends authentication request to a specific AP (say AP1) in the ESS. In the authentication frames exchange, the STA sets up multiple identification information (multiple ID or multiple RMA) (ESS grants multiple identification information to the STA, or the STA grants multiple identification information to ESS) and starts the FTM procedure.

The STA then starts to establish the second FTM session by sending authentication request to another AP in the ESS (say AP2). During this authentication frames exchanges, the STA uses one of the multiple identification information granted in first session.

When STA wants to start another FTM session (e.g., third FTM session with AP3), the STA uses another multiple identification information granted in first session.

As shown in FIG. 22, in the first FTM session, STA is granted ID1 and ID2. In the second FTM session, STA uses ID1 (granted from first session). In third session, STA uses ID2 (granted from first session).

It should be understood that the above embodiments are only for illustration but not limitation. The present disclosure may be carried out in other ways than those specifically set forth herein without departing from essential characteristics of the disclosure. All changes to these embodiments not departing from the meaning and equivalency of the appended claims are intended to be comprised herein.

### REFERENCES

802.11bh draft (D0.2), referring to: IEEE P802.11bh™ D0.2, May 2022, Draft Standard for Information technology-Telecommunications and information exchange between systems Local and metropolitan area networks-Specific requirements, Part 11: Wireless LAN Medium Access Control (MAC) and Physical Layer (PHY) Specifications, Amendment 7: Randomized and Changing MAC Addresses, Prepared by the 802.11 Working Group of the LAN/MAN Standards Committee of the IEEE Computer Society
802.11az, referring to: IEEE P802.11az™/D7.0, September 2022, Draft Standard for Information technology-Telecommunications and information exchange between systems Local and metropolitan area networks-Specific requirements, Part 11: Wireless LAN Medium Access Control (MAC) and Physical Layer (PHY) Specifications, Amendment 4: Enhancements for positioning, Prepared by the 802.11 Working Group of the LAN/MAN Standards Committee of the IEEE
802.11REVme_D1.3, referring to: IEEE P802.11-REVme™/D1.3, June 2022, Draft Standard for Information technology-Telecommunications and information exchange between systems Local and metropolitan area networks-Specific requirements/D1.3, June 2022, Part 11: Wireless LAN Medium Access Control (MAC) and Physical Layer (PHY) Specifications, Prepared by the 802.11 Working Group of the LAN/MAN Standards Committee of the IEEE Computer Society
[22/0296r8], referring to: IEEE 802.11-22/296r8, TGbh proposals, Date: 2022 Feb. 22, Jouni Malinen, Qualcomm, etc.
[22/187r2], referring to: IEEE 802.11-22/0187r2, Network generated Device ID, Date: 2022 Mar. 10, Jouni Malinen, Qualcomm
[22/925r2], referring to: IEEE 802.11-22/0925r2, Proposed Text for MAAD for TGbh Draft 0.2, Date: 2022-07, Graham SMITH (SRT Wireless)
[22/895r1], referring to: IEEE 802.11-22/0895r1, Proposed Text for Identifiable Random MAC, IRM-3, Date: 2022-06, Graham SMITH (SRT Wireless)
[22/888r2], referring to: IEEE 802.11-22/0888r2, Rule-based random MAC STA identification (RRCM), Date: 2022 Jun. 12, Orhan Okan Mutgan, Nokia, etc.

| ABBREVIATION | EXPLANATION |
|---|---|
| AP | Access Point |
| FTM | Fine Timing Measurement |
| IE | Information Element |
| PASN | Pre association security negotiation |
| PMK | Pairwise Master Key |
| PTK | Pairwise Transient Key |
| RCM | Random and Changing MAC |
| RMA | Random MAC Address |
| STA | Station |
| ESS | Extended Service Set |
| MAAD | MAC Address Designation |
| IRMA | Identifiable Random MAC Address |
| RRCM | Rule-based Random and Changing MAC Address |

1-38. (canceled)

39. A first apparatus comprising:
at least one processor;
and at least one memory storing instructions that, when executed by the at least one processor, cause the first apparatus at least to:
perform a first authentication procedure between the first apparatus and a second apparatus in a wireless local area network;
wherein a first identification information of the first apparatus is assigned during the first authentication procedure.

40. The first apparatus according to claim 39,
wherein the first identification information comprises an identification information element, IE, indicating a first identifier, ID of the first apparatus, or a first random media access control address (RMA) of the first apparatus.

41. The first apparatus according to claim 39, wherein the first apparatus is further caused to perform:
transmit, to the second apparatus, a first message of the first authentication procedure;
receive, from the second apparatus, a second message of the first authentication procedure; and
transmit, to the second apparatus, a third message of the first authentication procedure.

42. The first apparatus according to claim 41,
wherein the first identification information of the first apparatus is assigned by the second apparatus; and
wherein the first apparatus is further caused to: receive, from the second apparatus, the first identification information of the first apparatus in the second message of the first authentication procedure, or at least one parameter to generate the first identification information based on a predefined equation.

43. The first apparatus according to claim 41,
wherein the first apparatus is further caused to: assign the first identification information of the first apparatus.

44. The first apparatus according to claim 43, wherein the first apparatus is further caused to:
transmit, to the second apparatus, the first identification information of the first apparatus in the first or third message of the first authentication procedure; or
transmit, to the second apparatus, one or more parameters for the first apparatus and the second apparatus, wherein the one or more parameters are intended to be used to generate the first identification information based on a predefined equation.

45. The first apparatus according to claim 39, wherein the at least one processor; and the at least one memory storing instructions that, when executed by the at least one processor, further cause the first apparatus to:
perform a second authentication procedure between the first apparatus and the second apparatus.

46. The first apparatus according to claim 45, wherein the at least one processor; and the at least one memory storing instructions that, when executed by the at least one processor, further cause the first apparatus to:
transmit, to the second apparatus, a first message of the second authentication procedure including the first identification information of the first apparatus; and/or
transmit, to the second apparatus, a third message of the second authentication procedure including the first identification information of the first apparatus.

47. The first apparatus according to claim 46, wherein the at least one processor; and the at least one memory storing instructions that, when executed by the at least one processor, further cause the first apparatus to:
receive, from the second apparatus, a second message of the second authentication procedure including a second identification information, or at least one parameter to generate the second identification information based on predefined equation; or
transmit, to the second apparatus, the third message of the second authentication procedure including the second identification information.

48. The first apparatus according to claim 46,
wherein a second message of the second authentication procedure includes a status code to indicate a success or a failure of an identification of the first apparatus.

49. The first apparatus according to claim 48,
wherein the wireless local area network operates according to a standard of 802.11;
wherein the first apparatus comprises a non access point station (STA);
wherein the second apparatus comprises an access point (AP); and/or
wherein the first apparatus is un-associated with the second apparatus.

50. The first apparatus according to claim 49,
wherein the second apparatus is a first AP in an extended service set (ESS); and
wherein the ESS further comprises a second AP and a third AP.

51. The first apparatus according to claim 50, wherein the first apparatus is further caused to:
use the first identification information or a second identification information in a third authentication procedure between the first apparatus and the second AP; and
use the first or second identification information in a fourth authentication procedure between the first apparatus and the third AP.

52. A method, comprising:
performing a first authentication procedure between a first apparatus and a second apparatus in a wireless local area network;
wherein a first identification information of the first apparatus is assigned during the first authentication procedure.

53. A second apparatus comprising:
at least one processor; and
at least one memory storing instructions that, when executed by the at least one processor, cause the second apparatus at least to:
perform a first authentication procedure between a first apparatus and the second apparatus in a wireless local area network;
wherein a first identification information of the first apparatus is assigned during the first authentication procedure.

54. The second apparatus according to claim 53,
wherein the first identification information comprises an identification information element, IE, indicating a first identifier, ID, of the first apparatus, or a first random media access control address, RMA, of the first apparatus.

55. The second apparatus according to claim 53, wherein the first authentication procedure performed by the second apparatus further comprises:
receive, from the first apparatus, a first message of the first authentication procedure;
transmit, to the first apparatus, a second message of the first authentication procedure; and
receive, from the first apparatus, a third message of the first authentication procedure.

56. The second apparatus according to claim 55,
wherein the first identification information of the first apparatus is assigned by the second apparatus; and wherein the at least one processor; and the at least one memory storing instructions that, when executed by the at least one processor, further cause the second apparatus to:
transmit, to the first apparatus, the first identification information of the first apparatus in the second message of the first authentication procedure, or at least one parameter to generate the first identification information based on predefined equation.

57. The second apparatus according to claim 56,
wherein the first identification information of the first apparatus is assigned by the first apparatus.
